(19) United States
(12) Patent Application Publication
(10) Pub. No.: US 2025/0320612 A1
(43) Pub. Date: Oct. 16, 2025

(54) METHOD OF OPERATING WATER ELECTROLYSIS CELL

(71) Applicant: SEOUL NATIONAL UNIVERSITY R&DB FOUNDATION, Seoul (KR)

(72) Inventors: Jeyong YOON, Seoul (KR); Jaeyune Ryu, Seoul (KR); Sanghwi Han, Seoul (KR)

(21) Appl. No.: 18/806,779

(22) Filed: Aug. 16, 2024

(30) Foreign Application Priority Data
Apr. 12, 2024 (KR) 10-2024-0049511

(51) Int. Cl. C25B 1/50; C25B 1/04; C25B 9/23; C25B 11/031; C25B 11/042; C25B 11/046

(52) U.S. Cl. CPC C25B 1/50; C25B 1/04; C25B 9/23; C25B 11/031; C25B 11/042; C25B 11/046

(57) ABSTRACT

The present disclosure relates to a method of operating a water electrolysis cell that can improve long-term durability even under high current density operating conditions.

### BACKGROUND

### 1. Technical Field

The present disclosure relates to a method of operating a water electrolysis cell.

The present application claims priority to the Korean Patent Application No. 10-2024-0049511, filed on Apr. 12, 2024, the disclosure of which is incorporated herein by reference.

### 2. Related Art

Electrochemical water electrolysis is a technology that is eco-friendly and can produce high purity hydrogen, and is considered a key technology in the field of renewable energy that replaces existing fossil fuel-based systems. Water electrolysis technology is largely divided into alkaline water electrolysis, cation exchange membrane water electrolysis, anion exchange membrane water electrolysis, and solid oxide water electrolysis. Alkaline water electrolysis, which is in the commercial stage, has a relatively low electrode price and high durability, but shows low hydrogen productivity, whereas cation exchange membrane water electrolysis shows high hydrogen productivity, but has the limitation that expensive noble metal catalysts such as iridium has to be used. Meanwhile, since anion exchange membrane water electrolysis is theoretically the most economical and efficient among water electrolysis methods, many attempts have been made to commercialize it, but unresolved issues such as long-term durability issues still remain.

There have been attempts to improve the oxygen generation activity and durability of the electrode by forming a catalyst layer containing various catalysts such as noble metal oxide, perovskite-type oxide, and 3d-transition metal-based hydroxide on the surface of a porous substrate. However, although these attempts require complex manufacturing procedures and expensive material costs, they are still limited to confirming the effect at the laboratory scale, and it has been difficult to reproduce them within a large-area multi-stack system.

### SUMMARY

### Technical Problem

The technical problem to be solved by the present disclosure is to provide a method of operating a water electrolysis cell that can achieve both high performance and durability through electrode activation.

However, the problem to be solved by the present disclosure is not limited to the problems mentioned above, and other problems not mentioned will be clearly understood by those skilled in the art from the following description.

### Technical Solution

One embodiment of the present disclosure provides a method of operating a water electrolysis cell including electrodes containing one or more of nickel, iron, and cobalt, wherein a cycle of sequentially performing the following steps (i) and (ii) is performed one or more times:
(i) performing water electrolysis by supplying the current necessary for water electrolysis, and
(ii) activating the electrodes by applying a voltage of more than −1.2 V to less than 1.2 V, or supplying a current at a current density of −20 mA/cm² or more to −0.1 mA/cm² or less,
and when the water electrolysis cell is a half-cell, the voltage is V vs RHE, and when the water electrolysis cell is a full cell, the voltage is a potential difference between the cathode and the anode.

### Advantageous Effects

The method of operating a water electrolysis cell according to one embodiment of the present disclosure can provide excellent long-term durability even under operating conditions of high current density.

The method of operating a water electrolysis cell according to one embodiment of the present disclosure can be economical since it uses electrodes in which a separate catalyst layer as an oxygen generation electrode and/or a hydrogen generation electrode is not formed.

The method of operating a water electrolysis cell according to one embodiment of the present disclosure can have an excellent effect and excellent scalability even for large-area multi-stack systems.

The effect of the present disclosure is not limited to the above-described effects, and effects not mentioned will be clearly understood by those skilled in the art from this specification and the attached drawings.

### BRIEF DESCRIPTION OF DRAWINGS

FIG. 1 is a drawing schematically showing operation methods of Examples 1-1 to 1-3.

FIG. 2 is a drawing showing current densities of the cells measured in Examples 1-1 to 1-3 and Comparative Examples 1-1 and 1-2.

FIG. 3 is a drawing showing overvoltage differences (η₅₀ₕ−η₀ₕ) calculated for Examples 1-1 to 1-3 and Comparative Examples 1-1 to 1-3.

FIG. 4 is a drawing showing potentials of the working electrodes over time for Example 1-1 and Comparative Example 1-3.

FIG. 5 is a drawing showing overvoltage differences (η₅₀ₕ−η₀ₕ) calculated for Examples 1-1, 2-1, and 2-2.

FIG. 6 is a drawing showing Raman spectra when a potential of 1.7 V_{RHE} is applied to the initial state, the electrode of Example 1-1, and the electrode of Comparative Example 1-3.

FIG. 7 is a drawing showing Raman spectra over time measured while applying a potential of 0.6 V_{RHE} to the initial state, the electrode of Example 1-1, and the electrode of Comparative Example 1-3.

FIG. 8 is a drawing showing XPS analysis results for the NF electrode in the initial state, the electrode of Comparative Example 1-3, the electrode of Example 1-1, and the electrode of Example 2-2.

FIG. 9 is a drawing showing Fe contents contained in the NF electrode in the initial state, the electrode of Example 1-1, the electrode of Comparative Example 1-3, and the electrode of Example 2-2.

FIG. 10 is a drawing showing potentials of the working electrodes over time for Example 1-1 and Examples 2-3 to 2-5.

FIG. 11 is a drawing showing overvoltage differences (η₅₀ₕ−η₀ₕ) calculated for Example 1-1 and Examples 2-3 to 2-5.

FIG. 12 is a drawing schematically showing an operation method of Example 3-2.

FIG. 13 is a drawing showing current densities of the cells measured in Examples 3-1 to 3-6 and Comparative Example 2-1.

FIG. 14 is a drawing showing cell voltages over time for Example 3-2 and Comparative Example 2-2.

FIG. 15 is a drawing showing overvoltage differences (η₅₀ₕ−η₀ₕ) calculated for Examples 3-1 to 3-6, Comparative Example 2-1, and Comparative Example 2-2.

FIG. 16 is a drawing showing overvoltage differences (η₅₀ₕ−η₀ₕ) calculated for Examples 3-2 and 4-1 to 4-3.

FIG. 17 is a drawing showing voltages and resistances (HFR) of the cells measured for Example 5.

FIG. 18 is a drawing showing cell voltages over time in Example 5 and Comparative Example 3.

FIG. 19 is a drawing showing a stack voltage and an average cell voltage of Example 6.

### DETAILED DESCRIPTION

Throughout this specification, when a part “includes” a certain element, this means that it may further include other elements rather than excluding other elements, unless specifically stated to the contrary.

Throughout this specification, when a member is said to be located “on” another member, this includes not only cases where a member is in contact with another member, but also cases where another member exists between the two members.

Throughout this specification, the unit “part by weight” may refer to the weight ratio between each component.

Throughout this specification, “A and/or B” means “A and B, or A or B.”

Throughout this specification, the term “electrolyte solution” refers to an aqueous electrolyte solution that is supplied to a water electrolysis device and undergoes water decomposition (water splitting).

Throughout this specification, “V vs RHE” or “V_{RHE}” refers to the potential difference for a reversible hydrogen electrode (RHE).

One embodiment of the present disclosure provides a method of operating a water electrolysis cell including electrodes containing one or more of nickel, iron, and cobalt, wherein a cycle of sequentially performing the following steps (i) and (ii) is performed one or more times:
(i) performing water electrolysis by supplying the current necessary for water electrolysis, and
(ii) activating the electrodes by applying a voltage of more than −1.2 V to less than 1.2 V, or supplying a current at a current density of −20 mA/cm² or more to −0.1 mA/cm² or less,
and when the water electrolysis cell is a half-cell, the voltage is V vs RHE, and when the water electrolysis cell is a full cell, the voltage is a potential difference between the cathode and the anode.

The method of operating a water electrolysis cell according to one embodiment of the present disclosure may have excellent long-term durability even under high current density operating conditions in the step (i). In addition, the method may be economical since it is used without forming a separate catalyst layer on a porous nickel, iron, and/or cobalt-based electrode that was used as a carrier for supporting the catalyst in the conventional water electrolysis catalyst electrode as the oxygen generation electrode and/or the hydrogen generation electrode of the water electrolysis cell.

The method of operating a water electrolysis cell according to one embodiment of the present disclosure can have an excellent effect and excellent scalability even for large-area multi-stack systems.

According to one embodiment of the present disclosure, the water electrolysis cell may be a half-cell or a full cell.

The half-cell may be a three-electrode system including a working electrode, a counter electrode, a reference electrode, and an electrolyte.

When the water electrolysis cell is a half-cell, the water electrolysis cell includes an electrochemical catalyst electrode as a working electrode, and the electrochemical catalyst electrode may be an electrode containing one or more of nickel, iron, and cobalt. When the water electrolysis cell is a full cell, the water electrolysis cell includes at least one pair of electrodes, that is, a cathode and an anode, and an electrolyte. Here, one or more of the cathode and anode may be an electrode containing one or more of nickel, iron, and cobalt.

According to one embodiment of the present disclosure, when the water electrolysis cell is a full cell, the water electrolysis cell may further include a separator or an exchange membrane, and preferably may further include an anion exchange membrane. That is, the water electrolysis cell may be an anion exchange membrane water electrolysis cell.

According to one embodiment of the present disclosure, the anion exchange membrane may include a fluorinated polymer electrolyte or hydrocarbon-based polymer electrolyte material. Preferably, the exchange membrane may include a polycarbazole-based anion exchange material such as that disclosed in prior patent document 10-2284854 B1.

According to one embodiment of the present disclosure, if necessary, the water electrolysis cell may further include one or more of a bipolar plate, a gas diffusion layer (GDL), a gasket, a current collector plate, and an end plate.

The method of operating a water electrolysis cell according to one embodiment of the present disclosure may be applied to a water electrolysis system including one or more water electrolysis cells as a unit cell. The water electrolysis device may include a water electrolysis stack including a plurality of unit cells and a power supply unit that supplies electrical energy to the unit cells. Components or structures of the water electrolysis system are known in the art and may be added and/or changed as appropriate.

According to one embodiment of the present disclosure, the electrodes containing one or more of nickel, iron, and cobalt may contain nickel, iron, cobalt, or alloys thereof.

According to one embodiment of the present disclosure, the electrodes containing one or more of nickel, iron, and cobalt may have a porous structure. For example, the electrodes containing one or more of nickel, iron, and cobalt having the porous structure may be in the form of a foam, mesh, or felt.

According to one embodiment of the present disclosure, the electrolyte solution supplied to the water electrolysis cell may be alkaline. The electrolyte solution supplied to the water electrolysis cell may be maintained at a temperature of 40° C. to 80° C.

According to one embodiment of the present disclosure, the electrolyte solution may contain a trace amount of iron. Specifically, the content of a trace amount of iron contained in the electrolyte solution may be 10 ppb to 1,000 ppb. Preferably, the content of a trace amount of iron contained in the electrolyte solution may be 50 ppb to 100 ppb. When the content of a trace amount of iron contained in the electrolyte solution satisfies the above-described range, the performance improvement effect due to the method of operating a water electrolysis cell according to the present disclosure may be more excellent.

Below, each step of the operation method according to one embodiment of the present disclosure is described in more detail.

### (i) Performing Water Electrolysis by Supplying the Current Necessary for Water Electrolysis

According to one embodiment of the present disclosure, the step of performing water electrolysis by supplying the current necessary for water electrolysis may be to generate oxygen and hydrogen by decomposing water supplied to the water electrolysis cell.

According to one embodiment of the present disclosure, the current supplied in the step (i) may be a constant current.

According to one embodiment of the present disclosure, the current supplied in the step (i) may have a current density of 300 mA/cm² or more. More preferably, the current supplied in the step (i) may have a current density of 400 mA/cm² or more, 500 mA/cm² or more, 600 mA/cm² or more, 700 mA/cm² or more, 800 mA/cm² or more, 900 mA/cm² or more, or 1000 mA/cm² or more. Specifically, the current supplied in the step (i) may have a current density of 1000 mA/cm² to 2000 mA/cm². Since the amount of hydrogen produced per unit time in a water electrolysis cell is proportional to the current value flowing in the water electrolysis cell, when the current supplied in the step (i) has a current density of 500 mA/cm² or more or 1000 mA/cm² or more, the water electrolysis cell may have excellent water electrolysis performance.

According to one embodiment of the present disclosure, since the voltage of the water electrolysis cell required to perform water electrolysis at a constant current density increases as the performance time of the step (i) increases, the performance time of the step (i) may be adjusted depending on the upper voltage limit of the target cell. For example, the time for performing the step (i) may be 30 minutes to 24 hours, 30 minutes to 12 hours, 30 minutes to 10 hours, 1 hour to 24 hours, 1 hour to 12 hours, 1 hour to 6 hours, 1 hour to 3 hours, or 1 hour to 2 hours.

(ii) Activating the Electrodes by Applying a Voltage of More than −1.2 V to Less than 1.2 V, or Supplying a Current at a Current Density of −20 mA/cm² or more to −0.1 mA/cm² or Less

The step (ii) is a step of reactivating the electrodes containing one or more of nickel, iron, and cobalt, whose catalytic activities have decreased as the oxygen generation reaction or hydrogen generation reaction proceeds in the step (i).

The catalytic activities of the electrodes containing one or more of nickel, iron, and cobalt may be improved by applying a voltage of more than −1.2 V to less than 1.2 V to the water electrolysis cell or supplying a current to the water electrolysis cell at a current density of −20 mA/cm² or more to −0.1 mA/cm² or less in the step (ii). More specifically, the oxygen generation performance or hydrogen generation performance of the electrodes containing one or more of nickel, iron, and cobalt may be improved by performing the step (ii), and thus the overvoltage of the water electrolysis cell may be reduced on the step (i) performed after the step (ii).

According to one embodiment of the present disclosure, when the water electrolysis cell is a half-cell, the voltage may be V vs RHE, and when the water electrolysis cell is a full cell, the voltage may be a potential difference between the cathode and the anode.

According to one embodiment of the present disclosure, the voltage applied in the step (ii) may be more than −1.2 V to less than 1.2 V. Specifically, the range of the voltage applied in the step (ii) may have a lower limit selected from −1.1 V, −1.0 V, −0.9 V, −0.8 V, −0.7 V, −0.6 V, −0.5 V, −0.4 V and −0.3 V, and an upper limit selected from −0.01 V, −0.05 V, −0.1 V, −0.2 V and −0.3 V. More preferably, the voltage applied in the step (ii) may be −1.1 V or more to 1.1 V or less, −1.0 V or more to 1.0 V or less, −0.9 V or more to 0.9 V or less, −0.8 V or more to 0.8 V or less, −0.7 V or more to 0.7 V or less, −0.6 V or more to 0.6 V or less, −0.5 V or more to 0.5 V or less, or −0.4 V or more to 0.4 V or less.

According to one embodiment of the present disclosure, the voltage applied in the step (ii) may be a constant voltage.

According to one embodiment of the present disclosure, the current supplied in the step (ii) may be −20 mA/cm² or more to −0.1 mA/cm² or less, −20 mA/cm² or more to −1 mA/cm² or less, −15 mA/cm² or more to −0.1 mA/cm² or less, −15 mA/cm² or more to −1 mA/cm² or less, −10 mA/cm² or more to −0.1 mA/cm² or less, or −10 mA/cm² or more to −1 mA/cm² or less.

According to one embodiment of the present disclosure, the current supplied in the step (ii) may be a constant current.

According to one embodiment of the present disclosure, the step (ii) may be performed for 0.1 minutes or more to 60 minutes or less. More specifically, the performance time of the step (ii) may be within a range with a lower limit of 0.1 minute, 0.5 minute, 1 minute, 2 minutes, or 3 minutes, and an upper limit of 60 minutes, 50 minutes, 40 minutes, 30 minutes, 20 minutes, 10 minutes, 8 minutes, 6 minutes, 5 minutes, or 4 minutes.

Preferably, the performance time of the step (ii) may be 1 minute to 10 minutes. When the performance time of the step (ii) is 1 minute to 10 minutes, since the time required for activation is not long while activation of the electrodes is effective, a hydrogen production amount per unit time may be high.

The method of operating a water electrolysis cell according to one embodiment of the present disclosure performs a cycle of sequentially performing the steps (i) and (ii) described above one or more times.

According to one embodiment of the present disclosure, the ratio of the performance time of the step (i) and the performance time of the step (ii) may be 1:2 to 6000:1.

Preferably, the ratio of the performance time of the step (i) and the performance time of the step (ii) may be 5:1 to 200:1, 5:1 to 100:1, or 6:1 to 60:1. When the ratio of the performance time of the step (i) and the performance time of the step (ii) satisfies the above-described range, since the time required for activation is not long while the performance improvement of the water electrolysis cell is effective, a hydrogen production amount per unit time may be high.

In the method of operating a water electrolysis cell according to one embodiment of the present disclosure, the cycle may be performed 50 times or more. When the cycle is performed 50 times or more, the performance of the water electrolysis cell may be improved at a time point when the cycle is performed 50 times or more compared to the performance of the water electrolysis cell before performing the cycle (initial state). More specifically, the overvoltage for performing water electrolysis at the same current density may be reduced in a water electrolysis cell in which the cycle is performed 50 times or more compared to the initial state.

According to one embodiment of the present disclosure, the overvoltage (η₅₀) for the current density of 1000 mA/cm² of the water electrolysis cell after performing the cycle 50 times may be reduced by 5% to 40% compared to the overvoltage for the current density of 1000 mA/cm² of the water electrolysis cell in the initial state.

That is, the method of operating a water electrolysis cell according to one embodiment of the present disclosure may improve the oxygen generation performance and/or hydrogen generation performance of the water electrolysis cell as the number of cycles performed increases. More specifically, the performance improvement effect is noticeable when the number of the cycles performed is from 1 to 50, but after 50, the additional performance improvement effect may be insignificant.

Hereinafter, the present disclosure will be described in detail with reference to Examples in order to specifically describe the present disclosure. However, the Examples according to the present disclosure may be modified into various other forms, and the scope of the present disclosure should not be construed as being limited to the Examples described below. The Examples of this specification are provided to more completely explain the present disclosure to those skilled in the art.

### Experimental Example 1: Evaluation in a Half-Cell System

In a half-cell system including electrodes containing one or more of nickel, iron, and cobalt, it was evaluated whether the oxygen generation performance of the electrodes was improved by performing the operation method according to the present disclosure. Unless otherwise specified below, all electrochemical data were iR corrected based on ohmic resistance measured via Electrochemical Impedance Spectroscopy (EIS) at 10 KHz with 10 mV amplitude.

### Half-Cell for Evaluation

Electrochemical tests were performed by using an SP-150 potentiostat (BioLogic, France) using a nickel felt (NF) electrode as the working electrode, a saturated calomel electrode (SCE) as the reference electrode, and Pt foil as the counter electrode. Before the experiment, all components of the half-cell were cleaned with 1M H₂SO₄ and rinsed thoroughly with pure water (18.2 MΩcm, Milli-Q® Direct 8 system, Merck Millipore, MA, USA). The SCE potential was calibrated through CV tests using [Fe(CN)₆]⁴⁻/[Fe(CN)₆]³⁻ before and after the experiment. The NF electrode (thickness=250 μm, porosity=60%, fiber diameter=20 μm, 2Ni18-025, Bekaert) was used as a working electrode without pretreatment. KOH (90%, Sigma-Aldrich) was used to prepare the 1M KOH solution used as an electrolyte solution.

### Examples 1-1 to 1-3 and Comparative Examples 1-1 to 1-2

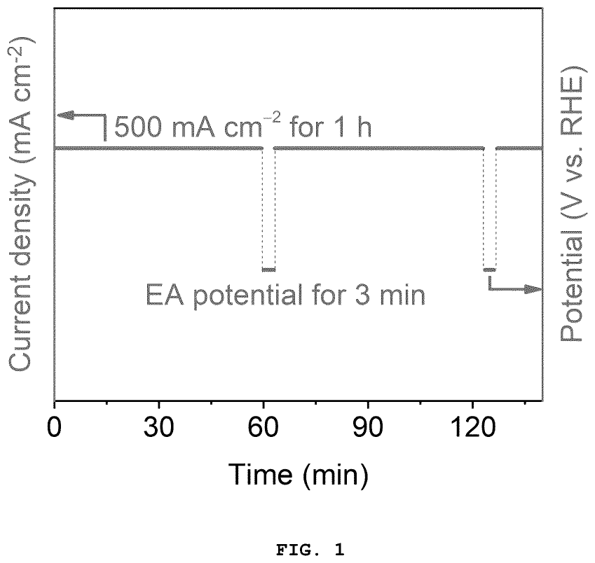

FIG. 1 is a drawing schematically showing operation methods of Examples 1-1 to 1-3.

As the step (i), a step of performing water electrolysis while supplying current at a current density of 500 mA/cm² was performed for 1 hour, and as the step (ii) after the step (i), a step of applying a constant voltage set as in Table 1 below was performed for 3 minutes. The half-cell was operated while repeating this as a cycle 50 times. During operation of the half-cell, the potential and resistance (HFR) of the NF electrode were measured at 10-minute intervals during the step (i), and the current density was measured at 1-minute intervals during the step (ii).

At this time, the Fe content contained in the electrolyte solution measured through ICP-MS using the NexION 350D system (PerkinElmer, USA) was about 76 ppb.

TABLE 1

| | | | | Comparative | Comparative |
|---|---|---|---|---|---|
| | Example 1-1 | Example 1-2 | Example 1-3 | Example 1-1 | Example 1-2 |
| Constant | 0.6 | 0.9 | 1.1 | 1.2 | 1.5 |
| voltage (VRHE) | | | | | |
| applied in the | | | | | |
| step (ii) | | | | | |

### Comparative Example 1-3

The half-cell was operated for 50 hours while performing water electrolysis by supplying current at a current density of 500 mA/cm² as the step (i) without performing the step (ii). The potential, resistance (HFR), and current density of the NF electrode were measured at 10-minute intervals.

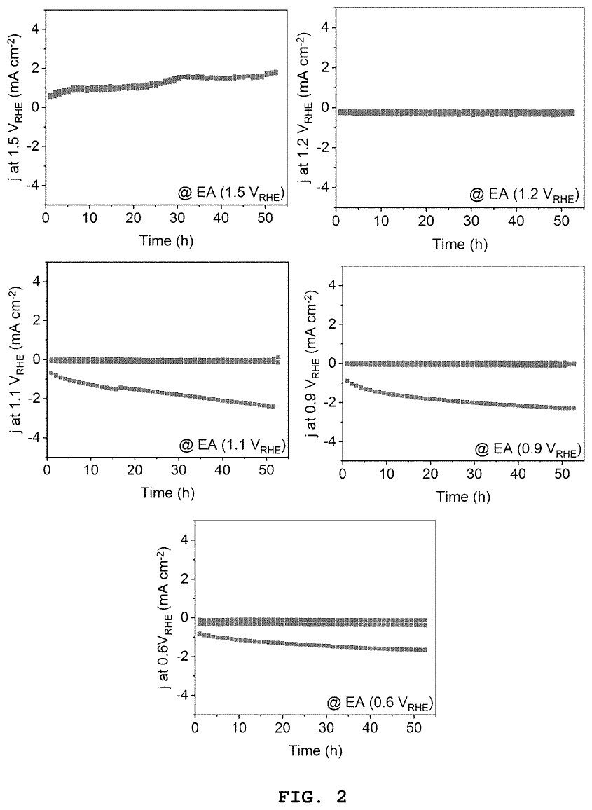

FIG. 2 is a drawing showing current densities of the cells measured in Examples 1-1 to 1-3 and Comparative Examples 1-1 and 1-2.

Referring to FIG. 2, it was confirmed that negative current densities occurred in Examples 1-1 to 1-3 in which the activation step was performed at 0.6, 0.9, and 1.1 V_{RHE}, respectively. This suggests that the NF electrode may be reduced by the negative current densities, thereby improving the catalytic activity of the NF electrode.

Overvoltage Comparison after 50 Hours of Operation

In order to confirm the overvoltage reduction effect according to the operation method in Examples 1-1 to 1-3 and Comparative Examples 1-1 to 1-3 after operating for 50 hours, the difference between an overvoltage (η₅₀ₕ) for a current density of 500 mA/cm² for the half-cell after operating for 50 hours according to the methods of Examples and Comparative Examples and an overvoltage (η₀ₕ) for a current density of 500 mA/cm² in the so-called initial state where the step (ii) has never once been performed was calculated.

Since the half-cells used in the Examples and the Comparative Examples are the same, it can be assumed that the overvoltages (η₀ₕ) for a current density of 500 mA/cm² in the initial state are the same. That is, it is suggested that the smaller the overvoltage difference (η₅₀ₕ−η₀ₕ) value, the smaller the overvoltage (η₅₀ₕ) for the current density of 500 mA/cm² of the half-cell in a state that it is operated for 50 hours, and the smaller the overvoltage, the more excellent the oxygen generation performance of the NF electrode.

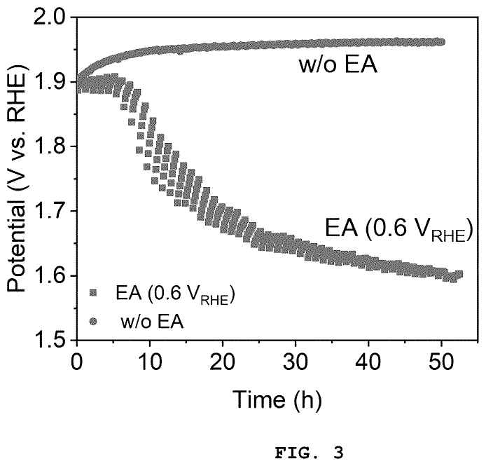

FIG. 3 is a drawing showing overvoltage differences (η₅₀ₕ−η₀ₕ) calculated for Examples 1-1 to 1-3 and Comparative Examples 1-1 to 1-3. Referring to FIG. 3, compared to Comparative Example 1-3 in which water electrolysis was continuously performed without an activation step, it was confirmed that the overvoltage η₅₀ₕ decreased in Examples 1-1 to 1-3 and Comparative Examples 1-1 to 1-2 in which a step of applying a constant voltage was performed.

Meanwhile, in Comparative Examples 1-1 and 1-2 in which the step of applying constant voltages of 1.2 V_{RHE} and 1.5 V_{RHE} was performed, the overvoltage increased after 50 hours compared to the initial state so that the oxygen generation performance of the electrodes was deteriorated, whereas in Examples 1-1, 1-2, and 1-3 in which the step of applying constant voltages of 0.6 V_{RHE}, 0.9 V_{RHE}, and 1.1 V_{RHE} was performed, the overvoltage was remarkably reduced after 50 hours compared to the initial state so that the effect of improving the oxygen generation performance of the electrodes was confirmed. In particular, in Examples 1-2 and 1-1 in which constant voltages of 0.9 V_{RHE} and 0.6 V_{RHE} were applied, it was confirmed that the overvoltage for a current density of 500 mA/cm² decreased by about 270 mV at a time point when the operation was performed for 50 hours compared to the initial state.

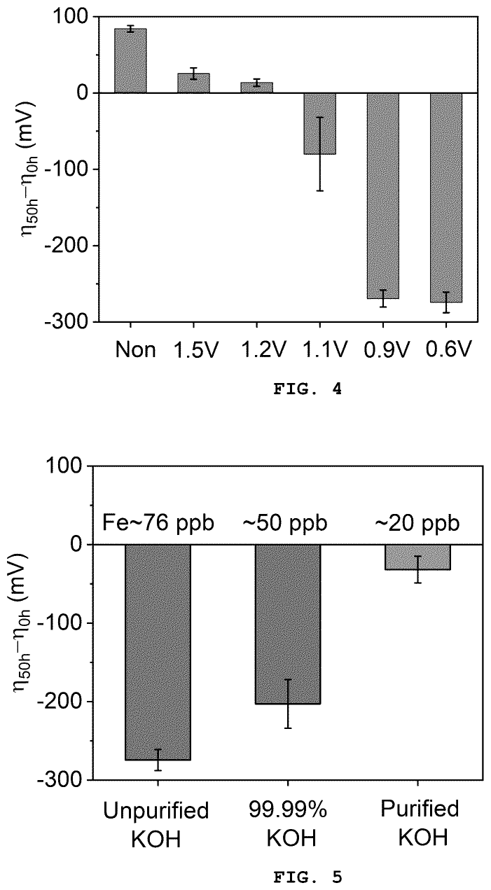

FIG. 4 is a drawing showing potentials of the working electrodes over time for Example 1-1 and Comparative Example 1-3. Referring to FIG. 4, in Comparative Example 1-3 in which water electrolysis was performed continuously without an activation step, the potential of the NF electrode increases over time, which indicates that the oxygen generation performance of the NF electrode deteriorates with operating time. On the other hand, it was confirmed that, in Example 1-1 in which the step of applying a constant voltage of 0.6 V_{RHE} was performed, the potential of the electrode increased during the step of performing water electrolysis, but the potential of the electrode decreased immediately after performing the step of applying the constant voltage, and a pattern of decreasing the potential of the electrode was shown as the cycle was repeated. It was confirmed that the overvoltage difference between Comparative Example 1-3 and Example 1-1 reached approximately 340 mV at a time point when 50 hours passed.

### Assessing the Impact of Trace Amounts of Iron Contained in Electrolyte Solutions

### Example 2-1

The half-cell was operated in the same manner as in Example 1-1 except that KOH (99.99%, Sigma-Aldrich) was used instead of KOH (90%, Sigma-Aldrich) in the preparation of the 1M KOH solution used as the electrolyte solution in the half-cell. During operation of the half-cell, the potential and resistance (HFR) of the NF electrode were measured at 10-minute intervals during the step (i), and the current density was measured at 1-minute intervals during the step (ii).

At this time, the content of Fe contained in the electrolyte solution measured through ICP-MS using the NexION 350D system (PerkinElmer, USA) was about 50 ppb.

### Example 2-2

The half-cell was operated in the same manner as in Example 1-1 except that the purified KOH solution (Purified KOH) was used as the electrolyte solution after the 1M KOH solution used as the electrolyte solution in the half-cell was purified using a precipitation method using Ni(NO₃)₂·6H₂O (99.9%, Sigma-Aldrich). During operation of the half-cell, the potential and resistance (HFR) of the NF electrode were measured at 10-minute intervals during the step (i), and the current density was measured at 1-minute intervals during the step (ii).

At this time, the content of Fe contained in the electrolyte solution measured through ICP-MS using the NexION 350D system (PerkinElmer, USA) was about 20 ppb.

FIG. 5 is a drawing showing overvoltage differences (η₅₀ₕ−η₀ₕ) calculated for Examples 1-1, 2-1, and 2-2. Referring to FIG. 5, after 50 hours of operation of the operating cycle including the activation step of applying a constant voltage of 0.6 V_{RHE}, the overvoltages of Examples 1-1, 2-1, and 2-2 all decreased, indicating that the OER performance of the NF electrode was improved. Meanwhile, as the concentration of a trace amount of Fe contained in the electrolyte solution increases, the degree of improvement in OER performance appears to be large, which shows that Fe contained in the electrolyte solution in the activation step is integrated into the nickel-based electrode to play an important role in improving the oxygen generation performance of the electrode.

Electrode Characterization after 50 Hours of Operation

In order to evaluate the effect of the activation step on the NF electrode, an electrode structure was investigated through in-situ Raman spectroscopy on the NF electrode in the initial state, the NF electrode (hereinafter referred to as the electrode of Example 1-1) after operating for 50 hours by the method of Example 1-1, and the NF electrode (hereinafter referred to as the electrode of Comparative Example 1-3) after being operated for 50 hours by the method of Comparative Example 1-3.

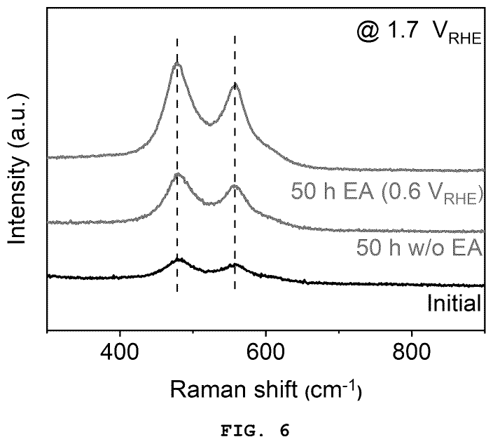

FIG. 6 is a drawing showing Raman spectra when a potential of 1.7 V_{RHE} is applied to the initial state, the electrode of Example 1-1, and the electrode of Comparative Example 1-3. The potential of 1.7 V_{RHE} is the potential where OER actively occurs. Referring to FIG. 6, peaks corresponding to NiOOH(Ni³⁺) were observed at 490 and 570 cm⁻¹ for all three electrodes, and the highest intensity peak was observed at the electrode of Example 1-1, which shows that the NiOOH phase increased at the electrode of Example 1-1.

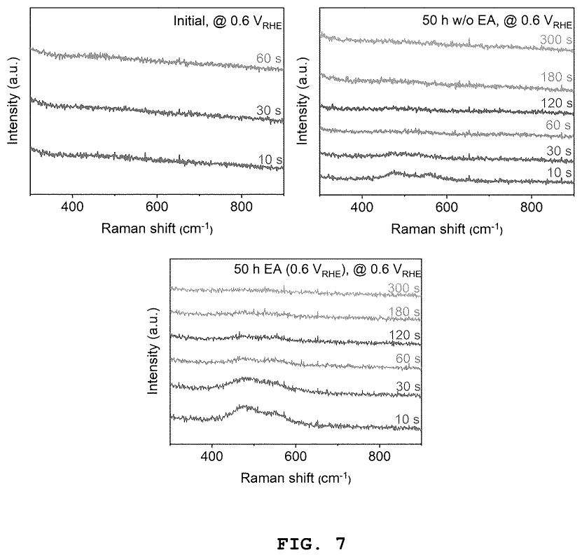

FIG. 7 is a drawing showing Raman spectra over time measured while applying a potential of 0.6 V_{RHE} to the initial state, the electrode of Example 1-1, and the electrode of Comparative Example 1-3. Referring to FIG. 7, the NiOOH phase did not appear in the NF electrode in the initial state even when a potential of 0.6 V_{RHE} was applied for only 10 seconds, the NiOOH phase lasted for about 30 seconds in the electrode of Comparative Example 1-3, and the NiOOH phase did not appear in the electrode of Example 1-1 after applying a potential of 0.6 V_{RHE} for about 60 seconds.

The electrodes of the initial state and Comparative Example 1-3 have less NiOOH phase than the electrode of Example 1-1, so it is expected that the NiOOH phase is reduced and disappears even with a shorter activation time, and this shows that almost all of the NiOOH phase can be reduced even with an activation step of about 10 seconds in the case of the initial state and about 60 seconds in the case of Comparative Examples 1-3. Meanwhile, the NiOOH phase in the NF electrode operated for 50 hours or more by the method of Example 1-1 was observed to persist without disappearing for about 3 minutes in the activation step. This suggests that about 3 minutes are needed for the NiOOH phase to be completely reduced to the Ni(OH)₂ phase in the activation step, and that a lot of the NiOOH phase is generated after operating for 50 hours and it takes more time to reduce the NiOOH phase.

Electrode structures were investigated by performing X-ray photoelectron spectroscopy (XPS) analysis on the NF electrode in the initial state, the electrode of Example 1-1, the electrode of Comparative Example 1-3, and the NF electrode (hereinafter referred to as the electrode of Example 2-2) after operating for 50 hours by the method of Example 2-2.

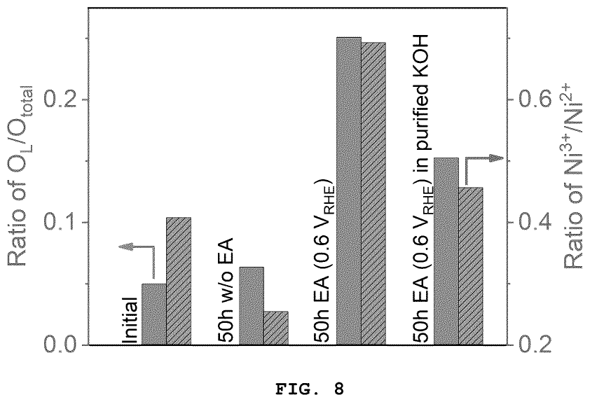

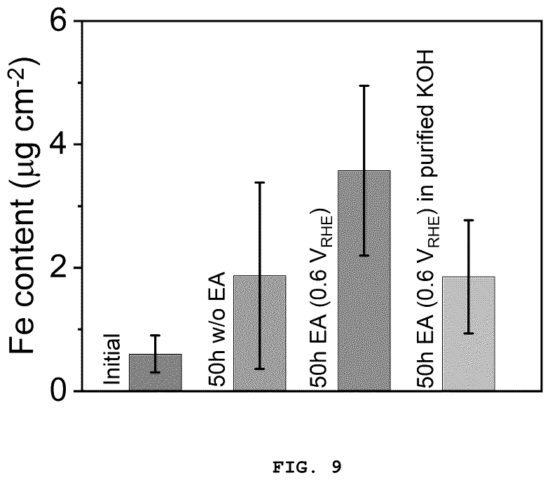

FIG. 8 is a drawing showing XPS analysis results for the NF electrode in the initial state, the electrode of Comparative Example 1-3, the electrode of Example 1-1, and the electrode of Example 2-2. The XPS O 1s spectrum was separated into peaks of lattice oxygen (O_{L}, up to 529.7 eV), hydroxyl (O_{OH}, up to 531.2 eV), and chemisorbed water (O_{W}, up to 532.4 eV). The XPS Ni 2p spectrum was separated into peaks of Ni²⁺ (up to 855.3 eV), Ni³⁺ (up to 856.8 eV), and satellite (up to 861.6 eV). The ratios of O_{L}/Oₜₒₜₐₗ and Ni³⁺/Ni²⁺ were calculated from the area of each peak.

Referring to FIG. 8, the NF electrode in the initial state was found to have an O_{L}/Oₜₒₜₐₗ ratio of about 0.05 and a Ni³⁺/Ni²⁺ ratio of 0.41. It was confirmed that the values of the O_{L}/Oₜₒₜₐₗ and Ni³⁺/Ni²⁺ ratios did not change significantly in the electrode of Comparative Example 1-3, whereas the O_{L}/Oₜₒₜₐₗ ratio increased to about 0.25 in the electrode of Example 1-1, and the Ni³⁺/Ni²⁺ ratio increased to 0.69. This suggests that the NiOOH phase increased in the NF electrode after operating for 50 hours by the method of Example 1-1, similarly to the results confirmed in the Raman spectrum results previously.

The contents of Fe contained in the electrodes were investigated using ICP-MS analysis performed on the NF electrode in the initial state, the electrode of Example 1-1, the electrode of Comparative Example 1-3, and the electrode of Example 2-2.

FIG. 9 is a drawing showing Fe contents contained in the NF electrode in the initial state, the electrode of Example 1-1, the electrode of Comparative Example 1-3, and the electrode of Example 2-2.

Referring to FIG. 9, the content of Fe contained in the electrode of Example 1-1 was about 2 μg·cm⁻², which was about twice the contents of Fe contained in the electrode of Comparative Example 1-3 and the electrode of Example 2-2. This indicates that Fe incorporation in the activation step occurs more effectively in Example 1-1, which used an unpurified KOH solution as an electrolyte solution, compared to Example 2-2, which used a purified KOH aqueous solution.

### Diversification of Activating Electrodes

### Example 2-3

In the half-cell for the above evaluation, the half-cell was operated in the same manner as in Example 1-1 above except that a nickel foam (Ni foam) electrode was used as the working electrode instead of the NF electrode. During operation of the half-cell, the potential and resistance (HFR) of the NF electrode were measured at 10-minute intervals during the step (i), and the current density was measured at 1-minute intervals during the step (ii).

### Example 2-4

In the half-cell for the above evaluation, the half-cell was operated in the same manner as in Example 1-1 except that a stainless steel (alloy of Ni/Fe/Cr) electrode was used as the working electrode instead of the NF electrode. During operation of the half-cell, the potential and resistance (HFR) of the NF electrode were measured at 10-minute intervals during the step (i), and the current density was measured at 1-minute intervals during the step (ii).

### Example 2-5

In the half-cell for the above evaluation, the half-cell was operated in the same manner as in Example 1-1 except that a cobalt foam (Co foam) electrode was used as the working electrode instead of the NF electrode. During operation of the half-cell, the potential and resistance (HFR) of the NF electrode were measured at 10-minute intervals during the step (i), and the current density was measured at 1-minute intervals during the step (ii).

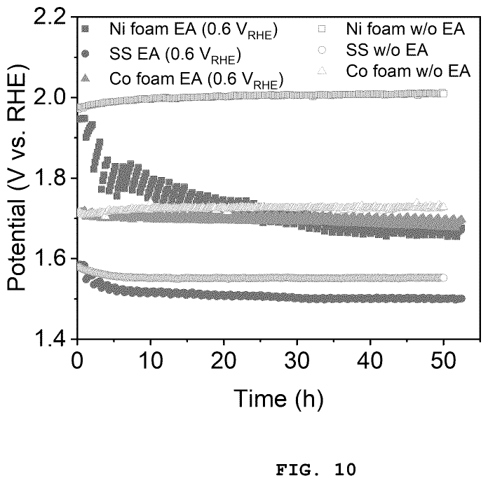

FIG. 10 is a drawing showing potentials of the working electrodes over time for Examples 1-1 and Examples 2-3 to 2-5.

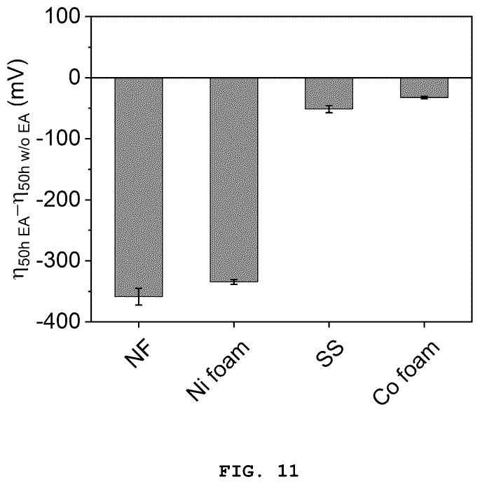

FIG. 11 is a drawing showing overvoltage differences (η₅₀ₕ−η₀ₕ) calculated for Example 1-1 and Examples 2-3 to 2-5.

Referring to FIGS. 10 and 11, even in the cases of Examples 2-2 and 2-3 using the stainless steel and cobalt foam electrodes as the working electrode, the effect of reducing overvoltage after 50 hours of operation by the operation method according to the present disclosure was confirmed. In particular, in the cases of Examples 1-1 and 2-3 using the NF electrode or Ni foam electrode as the working electrode, the amount of overvoltage reduction was the largest after 50 hours of operation, confirming that the effect of improving cell performance was excellent.

### Experimental Example 2: Evaluation in Anion Exchange Membrane Water Electrolysis Full Cells

The effect of the operation method according to the present disclosure was confirmed in an anion exchange membrane water electrolysis (AEMWE) full cell system. Unless otherwise specified below, all electrochemical data were iR-corrected based on ohmic resistance measured via EIS at 10 KHz with 10 mV amplitude.

### Full Cell System

In the full cell system, a nickel felt (NF) electrode and a Pt/C (loading amount: 1 mg·cm⁻²) electrode were used as a cathode and an anode, respectively, and a commercial anion exchange membrane (X37-50 grade RT from Dioxide Materials) was used as the exchange membrane. The cell was maintained at a temperature of 60° C. while circulating an unpurified 1M KOH solution as the electrolyte solution at a flow rate of 30 mL·min⁻¹.

### Examples 3-1 to 3-6 and Comparative Example 2-1

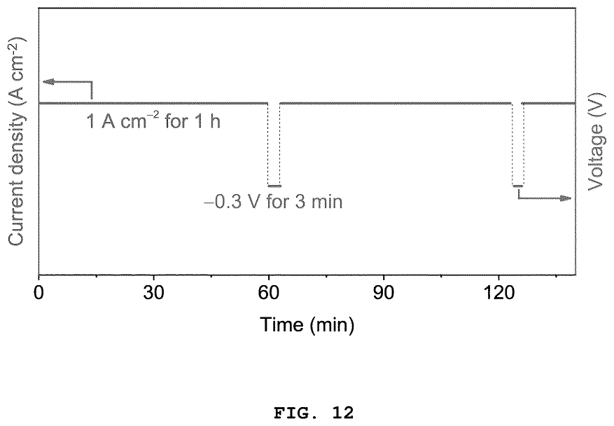

FIG. 12 is a drawing schematically showing an operation method of Example 3-2.

A step of performing water electrolysis while supplying current at a current density of 1000 mA/cm² as the step (i) is performed for 1 hour, and a step of applying a constant voltage set as shown in Table 2 below was performed for 3 minutes as a step (ii) after the step (i). This was considered one cycle, and the full cell was operated while repeating the cycle 50 times. During operation of a full cell, the voltage and resistance (HFR) of the cell were measured at 10-minute intervals during the step (i), and the current density was measured at 1-minute intervals during the step (ii).

TABLE 2

| | | | | | | | Comparative |
|---|---|---|---|---|---|---|---|
| | Example 3-1 | Example 3-2 | Example 3-3 | Example 3-4 | Example 3-5 | Example 3-6 | Example 2-1 |
| Constant | −0.5 | −0.3 | −0.1 | 0.1 | 0.5 | 1.0 | 1.5 |
| voltage | | | | | | | |
| (V) | | | | | | | |
| applied | | | | | | | |
| in the | | | | | | | |
| step (ii) | | | | | | | |

### Comparative Example 2-2

The full cell was operated for 50 hours while performing water electrolysis by supplying a current at a current density of 1000 mA/cm² as the step (i) without performing the step (ii).

### Examples 4-1 to 4-3

Full cells were operated while repeating the cycle 50 times in the same manner as in Example 3-2 except that the step (ii) of applying a constant voltage of −0.3 V in Example 3-2 was performed for the time shown in Table 3 below.

TABLE 3

| | Example 3-2 | Example 4-1 | Example 4-2 | Example 4-3 |
|---|---|---|---|---|
| Time (minutes) of | 3 | 1 | 5 | 10 |
| performing the step | | | | |
| (ii) | | | | |

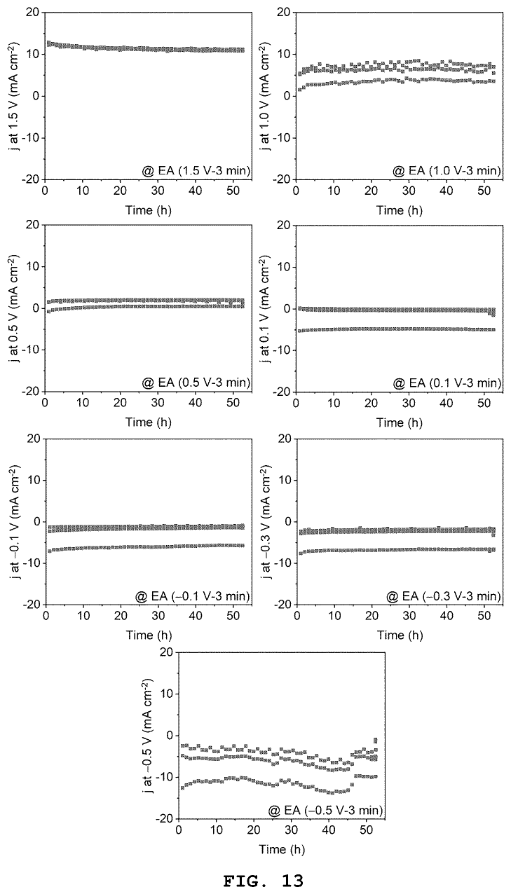

FIG. 13 is a drawing showing current densities of the cells measured in Examples 3-1 to 3-6 and Comparative Example 2-1.

Referring to FIG. 13, it was confirmed that negative current densities occurred in Examples 3-1 to 3-6 in which the activation step was performed at a voltage of −0.5 V to 1.0 V. This suggests that the NF electrode may be reduced by the negative current densities, thereby improving the catalytic activity of the NF electrode.

Overvoltage Comparison after 50 Hours of Operation

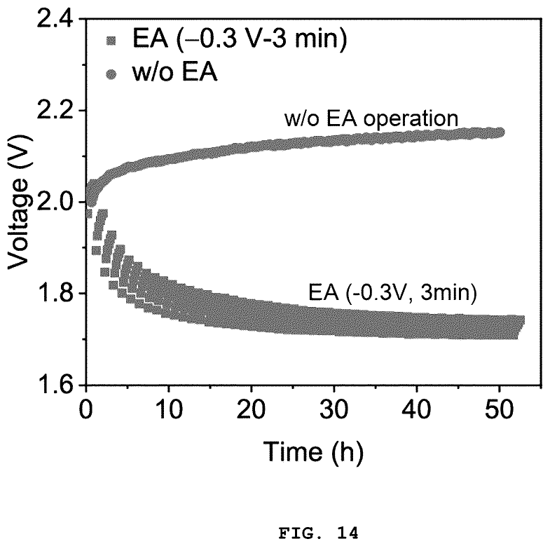

FIG. 14 is a drawing showing cell voltages over time for Example 3-2 and Comparative Example 2-2. Referring to FIG. 14, it was confirmed that Comparative Example 2-2, in which water electrolysis was continuously performed without an activation step, showed an aspect that the cell voltage increased over time and the water electrolysis performance deteriorated, whereas in Example 3-2, in which the activation step was performed at a constant voltage of −0.3 V, the cell voltage decreased over time, thereby improving water electrolysis performance.

In order to confirm the overvoltage reduction effect according to the operation method in Examples 3-1 to 3-6, Examples 4-1 to 4-3, and Comparative Examples 2-1 and 2-2 after operating for 50 hours, the difference between an overvoltage (η₅₀ₕ) for a current density of 1000 mA/cm² for the full cell after operating for 50 hours according to the methods of Examples and Comparative Examples and an overvoltage (η₀ₕ) for a current density of 1000 mA/cm² in the so-called initial state, where the step (ii) has never been performed, was calculated.

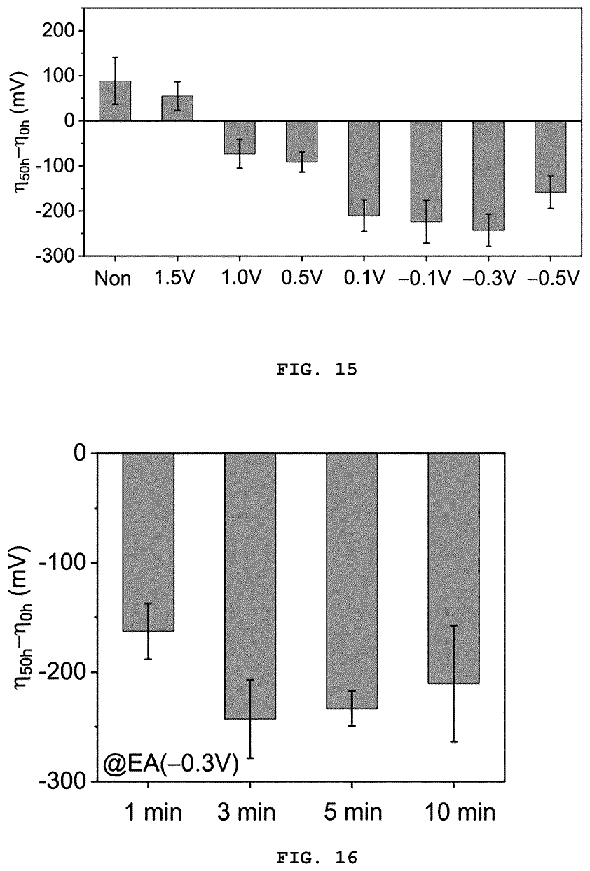

FIG. 15 is a drawing showing overvoltage differences (η₅₀ₕ−η₀ₕ) calculated for Examples 3-1 to 3-6, Comparative Example 2-1, and Comparative Example 2-2.

Referring to FIG. 15, even in the anion exchange membrane water electrolysis full cell system, it was confirmed that the methods of Examples 3-1 to 3-6 in which the activation step according to the present disclosure was performed greatly reduced the overvoltage and improved the water electrolysis performance of the cell compared to the operation methods in Comparative Examples 2-1 and 2-2 in which the activation step according to the present disclosure was not performed.

Specifically, in the operation method of Comparative Example 2-2 in which the activation step was not performed and the operation method of Comparative Example 2-1 in which a constant voltage of more than 1.2 V was applied, the overvoltage increased after 50 hours compared to the overvoltage in the initial state, confirming that the water electrolysis performance of the cell was deteriorated. On the other hand, in Examples 3-1 to 3-6 in which the activation step according to the present disclosure was performed, the overvoltage was reduced compared to the initial state, and the water electrolysis performance of the cell was improved, especially in Example 3-2 in which a constant voltage of −0.3 V was applied, the overvoltage decreased by about 243 mV after 50 hours of operation compared to the initial state, confirming that the performance improvement was most noticeable.

FIG. 16 is a drawing showing overvoltage differences (η₅₀ₕ−η₀ₕ) calculated for Examples 3-2 and 4-1 to 4-3.

Referring to FIG. 16, it was confirmed that performance was improved by reducing overvoltage in all of Examples 3-2, and 4-1 to 4-3 in which the performance time of the activation step (ii) was 1 minute to 10 minutes, and it was confirmed that the performance improvement was most noticeable in Example 3-2 in which the performance time was 3 minutes.

### Long-Time Operation Experiment

### Example 5

For the above-described full cell, as the step (i), a step of performing water electrolysis was performed for 1 hour while supplying a current at a current density of 1000 mA/cm², and after the step (i), as the step (ii), a step of applying a constant voltage of −0.3 V was performed for 3 minutes. This was considered one cycle, and operation was performed for 525 hours while repeating the cycle. After 525 hours, the exchange membrane was replaced with HQPC-TMA (polycarbazole-based anion exchange membrane), and operation was again carried out in the same manner as in Example 3-2 for up to 1050 hours. Only the step (i) above was performed from 1050 hours to 1100 hours, and the cycle was repeated thereafter.

### Comparative Example 3

For a full cell system in which a catalyst electrode (FeCo/NF) having the NF electrode electroplated with iron and cobalt is used instead of the NF electrode in the full cell described above, the full cell was operated for approximately 400 hours by performing water electrolysis while supplying current at a current density of 1000 mA/cm².

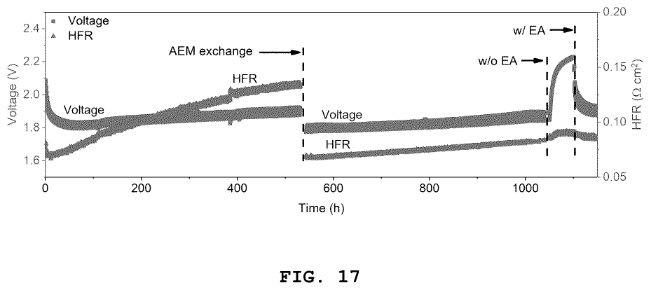

FIG. 17 is a drawing showing voltages and resistances (HFR) of the cells measured for Example 5. Referring to FIG. 17, in the 0 to 525 hour period when operation was performed using the operation method according to the present disclosure, the voltages of the cells decreased to about 1.8 V compared to the voltage of the initial state that was about 2.1 V, thereby improving performance. However, there was a pattern showing that, as time increased, the voltages of the cells increased somewhat to 1.9 V, and the resistances also increased somewhat. This is believed to be a deterioration in cell performance due to the deterioration of the exchange membrane, and when the exchange membrane was replaced after 525 hours, the resistances increased to less than 0.1 Ωcm² during the subsequent operation period of in the section of 525 to 1050 hours, confirming excellent durability. Furthermore, as the cells were operated without performing the activation step for 1,050 to 1,100 hours, the voltages of the cells increased greatly to about 2.2 V, and performance deteriorated. However, it was confirmed that the voltages of the cells restored to 1.9 V within a short period of time as the operation was performed again while repeating the above cycle after 1,100 hours.

These results support the sustainable operation of the operation method according to the present disclosure and suggest that the operation method of the water electrolysis cell of the present disclosure may be effectively performed for a longer time by using a high-quality exchange membrane.

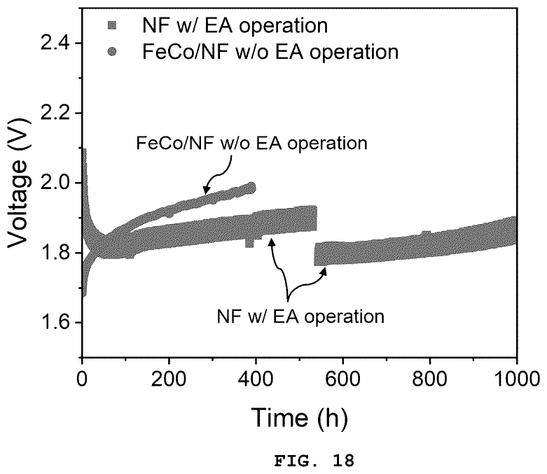

FIG. 18 is a drawing showing cell voltages over time in Example 5 and Comparative Example 3.

Referring to FIG. 18, water electrolysis performance was excellent in the initial state (0h) since the cell voltage of Comparative Example 3 using a full cell including iron-coated electrodes was about 1.7 V, which was lower than that of Example 5 using NF electrodes. However, the cell voltage decreases over time in Example 5 according to the operation method of the present disclosure, whereas the cell voltage increases in Comparative Example 3, and it was confirmed that the cell voltage was lower in the operation of Example 5 after about 50 hours compared to Comparative Example 3. Such results show that, even though a Ni-based electrode not coated with a separate catalyst layer was used as the oxygen generation electrode, much more excellent water electrolysis performance could be obtained than the water electrolysis of a cell using electrodes coated with a catalyst layer according to the operation method of the present disclosure.

### Multi-Stack Operation Experiment

To evaluate the feasibility of implementation in a large-area multi-stack configuration, a 3-cell stack AEMWE system was implemented using a customized stack. The hardware used in the stack consists of a Pt-coated Ti-based separator with a four-channel serpentine flow field, end plates, and an Au-coated current collector plate. After sealing each membrane electrode assembly (MEA) with two PTFE film gaskets, the stack was assembled with a torque of 10.0 Nm. The MEA used HQPC-TMA (thickness: 30 μm), an NF electrode (area: 25 cm²) as the cathode, and a Pt/C electrode (area: 25 cm²) as the anode. As an electrolyte solution, an unrefined 1M KOH solution was circulated at a flow rate of 75 mL/min and a temperature of 60° C.

### Example 6

For the 3-cell stack AEMWE, a step of performing water electrolysis while supplying a current at a current density of 1000 mA/cm² was performed for 1 hour as the step (i), and a step of supplying a constant current at a current density of −5 mA/cm² was performed for 3 minutes as the step (ii) after the step (i). This was considered one cycle, and operation was performed for 525 hours while repeating the cycle. After 525 hours, the exchange membrane was replaced with HQPC-TMA, and operation was performed again in the same manner as in Example 3-2 up to 1050 hours. Only the step (i) above was performed from 1050 hours to 1100 hours, and the cycle was repeated again thereafter.

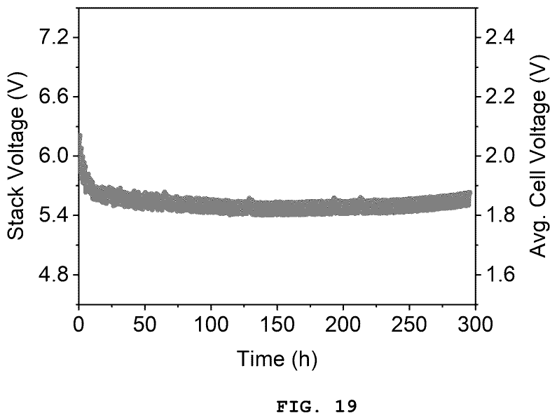

FIG. 19 is a drawing showing a stack voltage and an average cell voltage of Example 6.

Referring to FIG. 19, in Example 6 according to the operation method according to the present disclosure using a large-area 3-cell stack water electrolysis device, it was confirmed that the voltage of each cell and the voltage of the stack are maintained without increasing for about 300 hours, and the performance is excellent.

Although the present disclosure has been described above with limited Examples, the present disclosure is not limited thereto, and it goes without saying that various modifications and variations can be made by those skilled in the art to which the present disclosure pertains within the technical idea of the present disclosure and the equivalent scope of the claims to be described below.

What is claimed is:

1. A method of operating a water electrolysis cell including electrodes containing one or more of nickel, iron, and cobalt, wherein a cycle of sequentially performing the following steps (i) and (ii) is performed one or more times:
(i) performing water electrolysis by supplying current necessary for water electrolysis, and
(ii) activating the electrodes by applying a voltage of more than −1.2 V to less than 1.2 V, or supplying a current at a current density of −20 mA/cm² or more to −0.1 mA/cm² or less,
and when the water electrolysis cell is a half-cell, the voltage is V vs RHE, and when the water electrolysis cell is a full cell, the voltage is a potential difference between a cathode and an anode.

2. The method of claim 1, wherein the step (ii) is performed for 0.1 minutes or more to 60 minutes or less.

3. The method of claim 1, wherein a ratio of the performance time of the step (i) and the performance time of the step (ii) is 1:2 to 6000:1.

4. The method of claim 1, wherein the current supplied in the step (i) has a current density of 300 mA/cm² or more.

5. The method of claim 1, wherein the voltage applied in the step (ii) is −0.5 V or more to 0.5 V or less.

6. The method of claim 1, wherein the voltage applied in the step (ii) is a constant voltage.

7. The method of claim 1, wherein the current supplied in the step (ii) is a constant current.

8. The method of claim 1, wherein an electrolyte solution supplied to the water electrolysis cell is alkaline.

9. The method of claim 8, wherein the electrolyte solution contains a trace amount of iron.

10. The method of claim 1, wherein the electrodes have a porous structure.

11. The method of claim 1, wherein the water electrolysis cell is an anion exchange membrane water electrolysis cell.

12. The method of claim 1, wherein the cycle is performed 50 times or more.

13. The method of claim 12, wherein an overvoltage (η₅₀) for the current density of 1000 mA/cm² of the water electrolysis cell after performing the cycle 50 times is reduced by 5% to 40% compared to the overvoltage for the current density of 1000 mA/cm² of the water electrolysis cell in an initial state.
